(19) United States
(12) Patent Application Publication
(10) Pub. No.: US 2018/0009101 A1
(43) Pub. Date: Jan. 11, 2018

(54) TOTES OR BINS AND SYSTEMS & METHODS FOR STORING PRODUCTS

(71) Applicant: Wal-Mart Stores, Inc., Bentonville, AR (US)

(72) Inventors: Michael L. Piccininni, Nobleton (CA); Remon Hanna, Milton (CA); Abiy Wubneh, Edmonton (CA); Kevin R. McTavish, Sherwood Park (CA); Brett T. Gibson, Caledon (CA); Eddy Saihung Tai, Richmond Hill (CA)

(21) Appl. No.: 15/644,161

(22) Filed: Jul. 7, 2017

Related U.S. Application Data
(63) Continuation-in-part of application No. 29/599,435, filed on Apr. 3, 2017.
(60) Provisional application No. 62/360,122, filed on Jul. 8, 2016.
(60) Provisional application No. 62/480,943, filed on Apr. 3, 2017.

(51) Int. Cl. B25H 3/02; B62B 3/16; B65D 21/02; B65D 21/00; B25H 3/00

(52) U.S. Cl. CPC B25H 3/021; B62B 3/16; B65D 21/0223; B25H 3/00; B65D 21/00; B62B 2202/12

(57) ABSTRACT

An apparatus, system and method for storing and picking product in a plastic tote are disclosed. In one form, the tote is a plastic receptacle with a generally planar bottom and upstanding walls extending from the bottom and defining a receptacle opening on a side opposite the bottom, the upstanding walls forming a front wall, opposing side walls and a rear wall, with the walls extending from the bottom at an obtuse angle so that the receptacle tapers from a larger cross-section at the receptacle opening to a smaller cross-section at the bottom, and with at least one upstanding wall defining a first male or female mating structure for aligning with a second female or male mating structure of a second plastic receptacle when nested with the second plastic receptacle. Related systems and methods are also disclosed including without limitation pick and pack systems and methods.

### CROSS-REFERENCE TO RELATED APPLICATION

This application claims the benefit of the U.S. Provisional Application No. 62/360,122, filed Jul. 8, 2016 and U.S. Provisional Application No. 62/480,943, filed Apr. 3, 2017, and is a continuation in part of U.S. Design application Ser. No. 29/599,435, filed Apr. 3, 2017, all of which are incorporated herein by reference in their entirety herein.

### TECHNICAL FIELD

This invention relates generally to storage of products in the retail store environment and retail store supply chain and, more particularly, to tote or bin receptacles and systems for the efficient storage of products and methods relating to same.

### BACKGROUND

Some primary objectives of retailers (whether brick and mortar retailers, ecommerce retailers/etailers or both) are to provide consumers with the items they want and to do so as efficiently as possible so as to maximize sales. An important factor in accomplishing this objective is to have timely and accurate delivery of products so that the retailer can continue to operate smoothly and ensure the products desired by consumers are delivered on-time. To achieve this goal, many retailers and retail store supply chains are setup for pick and pack processing where products are brought in by bulk, broken down into warehouse totes or bins that employees or associates go to in order to pick a product that has been ordered. Most of these retailers utilize warehouse management system (WMS) products or software that process an order, send an associate to the proper warehouse tote to pick the ordered item (or some bring the shelving with the item to associate to perform the pick without traveling to a fixed shelf location) and then the associate performs the “pick” by pulling the requested number of products from the warehouse tote and placing same in another receptacle or container, such as an order tote which moves on to complete the rest of the order and eventually to the facility's shipping area. Such facilities may be setup to handle direct-to-store orders (meaning the facility is filling a retailer's order who will then get the product to the end consumer) and/or they may be setup to handle direct-to-consumer orders (meaning the facility is filling the end consumer's order and will be shipping directly to the end consumer on behalf of the retailer).

Conventional totes that are used for the temporary storage of product and utilized by associates to perform “picks”, such as at fulfillment centers, are typically made of cardboard and have labels on the front of the cardboard tote (e.g., bin location tags, etc.) identifying the products contained therein. Usually these totes have dimensions of less than four feet (4′) in order to fit on standard pallet racks or commercial warehouse shelving.

Several problems have been associated with such totes, however, in that they breakdown too easily given the volume of times they are utilized by associates and the wear and tear associated with same. Similarly, the weakness of the cardboard material prevents the totes from being stackable (making for wasted space on the warehouse shelves and within the warehouse in general) and hard to sub-divide with dividers so that individual products can be separated from one another which can protect the stored product and/or make it easier for associates to perform their required pick activity. Material weakness also makes the totes susceptible to breakage and/or infestations. Breakdowns or breakage, such as tears in sidewalls or sidewall collapses, can result in the comingling of stored product and/or presence of the incorrect product in a tote, and ultimately this can lead to inventory and order errors. The indicia (e.g., labels or bin location tags, etc.) that are placed on such cardboard totes are also susceptible to damage due to the weakness of the tote material and its susceptibility to wear and tear. Further, such conventional totes cannot be used with product that have condensation buildup or in environments with high humidity due to how such moisture can breakdown or negatively impact the cardboard. For similar reasons, such conventional totes cannot be used with food or other products that require the tote to be washed or cleaned. Other problems associated with such totes is that they are fully enclosed which can cause problems should water be introduced into the environment, such as by a leaking roof, broken or damaged product containing liquid, a sprinkler systems or other fire abatement activity, etc.

Accordingly, it has been determined that a need exists for improved systems, apparatus and methods for storing product for retailers and, more particularly, totes and storage systems that overcome the aforesaid problems associated with conventional totes and systems, and improved methods relating to same.

### BRIEF DESCRIPTION OF THE DRAWINGS

Disclosed herein are embodiments of systems, apparatuses and methods for storing product for retailers.

This description includes drawings, wherein:

FIGS. 1A and 1B are perspective views taken from below and above, respectively, of a tote or bin in accordance with some embodiments of the invention;

FIG. 1C is a perspective view of the tote or bin of FIGS. 1A-1B illustrated with exemplary dividers which may be used to separate the tote or bin into individual product compartments or smaller product compartments;

FIG. 1D is a perspective view of multiple totes or bins in accordance with the tote or bin of FIGS. 1A-1B, illustrating an exemplary manner in which the totes or bins may be stacked and even nested with one another;

FIG. 2A is a perspective view taken from above of a tote or bin in accordance with other embodiments of the invention and illustrating optional side and/or bottom openings in the unit;

FIG. 2B is a partial perspective view of the tote or bin of FIG. 2A taken from below one end of the unit;

FIG. 2C is a partial perspective view of the tote or bin of FIG. 2A, with the tote or bin inverted and illustrating different side openings in the structure;

FIG. 3A is a front view of a divider in accordance with some embodiments of the invention; and

FIG. 3B is a cross sectional view of the divider of FIG. 3A in accordance with some embodiments of the invention.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking and pursuant to various embodiments, systems, apparatus and methods/processes are provided herein for storing products in a plastic tote-type receptacle. For example, in some forms, the tote is a plastic receptacle with a generally planar bottom and upstanding walls extending from the bottom and defining a receptacle opening on a side opposite the bottom, the upstanding walls forming a front wall, opposing side walls and a rear wall, with the walls extending from the bottom at an obtuse angle so that the receptacle tapers from a larger cross-section at the receptacle opening to a smaller cross-section at the bottom, and with at least one upstanding wall defining a first male or female mating structure for aligning with a second female or male mating structure of a second plastic receptacle when nested with the second plastic receptacle. Related systems and methods are also disclosed including without limitation pick and pack systems and methods, such as those used by direct-to-store retailers and direct-to customer-retailers (e.g., ecommerce retailers or etailers).

In other forms, the front wall may further include a handle and a recess defining a viewing window to see products stored in the plastic receptacle even when the receptacle is stored on a shelf. In a preferred form, both the handle and recess will be formed integral to the front wall of the receptacle. In the form shown, the recess comprises a generally U-shaped opening in an upper portion of the front wall, with a protruding lip extending from a lower portion of the U-shaped opening defining at least a portion of the handle.

The tote may further include one or more dividers and have opposing side walls that define mating structures for engaging corresponding surfaces of the dividers to position the dividers in such a way as to divide the tote into separate internal compartments. In one form, the divider mating structures are recesses formed in an inner surface of each of the opposing side walls of the tote, with recesses located opposite one another for receiving exterior surfaces of a single divider or the same divider. The opposing side walls may be positioned closer to one another than the front and rear walls are to one another so that the plastic tote defines a product channel having a longitudinal axis running between the front and rear walls. In such a configuration, the one or more dividers would preferably be connected to the plastic tote in a manner that is transverse to the longitudinal axis of the product channel defined by the plastic tote.

In other embodiments, the tote may have exterior and interior structures that are designed to correspond or mate with one another so that the totes may be stacked or nested one atop the other. For example, in one form, the at least one upstanding wall defining the first male or female mating structure of the tote could comprise a plurality of male protrusions extending from interior surfaces of the opposing side walls and having corresponding female recesses on exterior surfaces of the side walls opposite the male protrusions so that the male protrusions of the first plastic receptacle are slidable within the exterior female recesses of the second plastic receptacle in order to stack and nest the receptacles to one another. In some forms the mating structures may engagement with one another and/or help guide one tote into alignment with the other tote. However, in other embodiments the structures may not engage one another, but simply align with each other to allow the units to be stacked.

In other forms, the at least one upstanding wall defining the first male or female mating structure of the tote may comprise a plurality of female recesses within interior surfaces of the opposing side walls and having corresponding male protrusions on exterior surfaces of the side walls opposite the female recesses so that the male protrusions of the second plastic receptacle are slidable within or align with the female recesses of the first plastic receptacle in order to stack and nest the receptacles to one another. In still other forms, the at least one upstanding wall defining the first male or female mating structure of the tote may include a plurality of male protrusions and female recesses on interior surfaces of the opposing side walls and having corresponding female recesses and male protrusions on exterior surfaces of the side walls opposite the male protrusions and female recesses of the interior surface, respectively, so that the female recesses and male protrusions on an exterior surface of the second plastic receptacle are slidable within or aligned with the male protrusions and female recesses, respectively, on the interior surface of the first plastic receptacle in order to align and/or matingly stack and nest the receptacles to one another.

In yet other embodiments, the tote may include openings for providing ventilation, drainage and/or for lightening the weight of the tote. For example, in one form, at least one of the bottom and/or opposing side walls define openings to allow for venting or drainage of the plastic receptacle. In a preferred form, the bottom defines a plurality of openings laid out in a pattern. The pattern may be a uniform grid pattern of openings or may take on other patterns, such as any repetitive design, or even random designs. In addition to having openings in the bottom surface of the tote or in lieu of same, the opposing side walls of the tote may define all or at least a portion of the openings for venting or drainage of the plastic receptacle. Similarly, in still other forms, a portion of the opposing side walls and a portion of the bottom of the tote may define the openings for venting or drainage of the plastic receptacle. In a preferred form, the bottom defines rounded openings having a vertical axis passing through the rounded openings as a first form of opening and the opposing side walls and/or bottom define elongated slots as a second form of opening. At least one of the elongated slots may extends from one of the opposing side walls to the bottom thereby wrapping around a bottom edge of the plastic receptacle, if desired.

In still other forms, the apparatus or system may include a plurality of plastic totes stackable and/or nestable within one another to maximize packout within a warehouse shelving unit and for transportation. This is particularly important when a need exists to store as many products as possible within a facility (e.g., such as when a retailer is paying for space in a warehouse facility, which thereby necessitates that the retailer be as efficient as possible with the space it is using to maximize packout or storage in same). In storage facilities or warehouses that utilize conventional warehouse shelving situated to accommodate standard four foot pallets, it is common for the conventional warehouse shelving to be positioned adjacent one another (e.g., back-to-back, etc.) with each shelving unit having a four foot shelf depth, meaning the two shelving units combined provide a bin or shelf depth of eight feet. Conventional totes or bins do not take advantage of the full bin length available when shelving units are placed adjacent one another like this. Thus, in some forms, the opposing side walls of the plastic receptacle disclosed herein are spaced closer to one another than the opposing front and rear walls of the tote are to one another and the opposing front and rear walls of the tote have a length extending between them that is greater than four feet and less than or equal to eight feet to allow the plastic receptacle to extend over two conventional warehouse shelving units positioned adjacent one another. This allows the tote to utilize the entire bin space available by the adjacent shelving units.

In some forms, the front wall of the tote includes a first handle and the rear wall includes a second handle so that a user can grasp the plastic receptacle from either end or either side of the two conventional warehouse shelving units positioned adjacent one another to access product contained in the plastic receptacle. Thus, rather than having to walk around a shelving unit to get to another shelving unit, products stored across both shelving units can be accessed via an elongated tote such as that contemplated herein. In other forms, however, totes in accordance with this disclosure may be much smaller. For example, the tote may have a length from front to back that is no greater than four feet in order to properly sit within and on one shelf of one of the shelving units. Other bins contemplated herein may have a length that is far shorter than that (e.g., several inches, rather than feet). Similarly, while the preferred embodiments discussed herein have a tote width that is far narrower than the length of the tote, it is also contemplated that other totes in accordance with this invention may be designed to be wider than they are narrow, to be square, or to take on any shape or dimension that fits within the standard four foot depth of conventional warehouse shelving or eight foot depth of two shelving units positions adjacent one another.

In addition to the various apparatus or totes described above, new pick and place methods for warehouse management are also contemplated herein. For example, one such method comprises providing a plastic receptacle like any of those discussed above wherein the front wall defines a first handle and the rear wall defines a second handle, and the method further including the step of positioning the plastic receptacle on first and second conventional warehouse shelving units positioned adjacent one another so that the user can grasp the plastic receptacle from either the first handle proximate the first conventional warehouse shelving unit or the second handle proximate the second conventional warehouse shelving unit, and then moving the plastic receptacle between a first position wherein the plastic receptacle is intermediately positioned or centered between the first and second conventional warehouse shelving units so that neither the front end nor the rear end extends beyond an outer edge of the first and second conventional warehouse shelving units, respectively. Moving the plastic receptacle may comprise moving the plastic receptacle between a first extended position wherein the front wall of the plastic receptacle protrudes from the first conventional warehouse shelving unit and a second extended position wherein the rear wall of the plastic receptacle protrudes from the second conventional warehouse shelving unit.

Pick and pack systems are also contemplated herein wherein a plurality of plastic receptacles according to any of the plastic receptacles discussed above are positioned adjacent one another in a row on shelving surfaces comprised of a first and second conventional warehouse shelving units which are also positioned adjacent one another. The plurality of plastic receptacles may be positioned proximate one another in multiple rows on multiple shelving surfaces defined by the first and second conventional warehouse shelving units which are also positioned adjacent one another. In some forms, the plurality of plastic receptacles are arranged in a plurality of rows of plastic receptacles with an upper row of the plurality of plastic receptacles being formed by stacking or nesting the upper row of the plurality of plastic receptacles on top of a lower row of the plurality of plastic receptacles to make more efficient use of the shelving surfaces comprised of the first and second conventional warehouse shelving units.

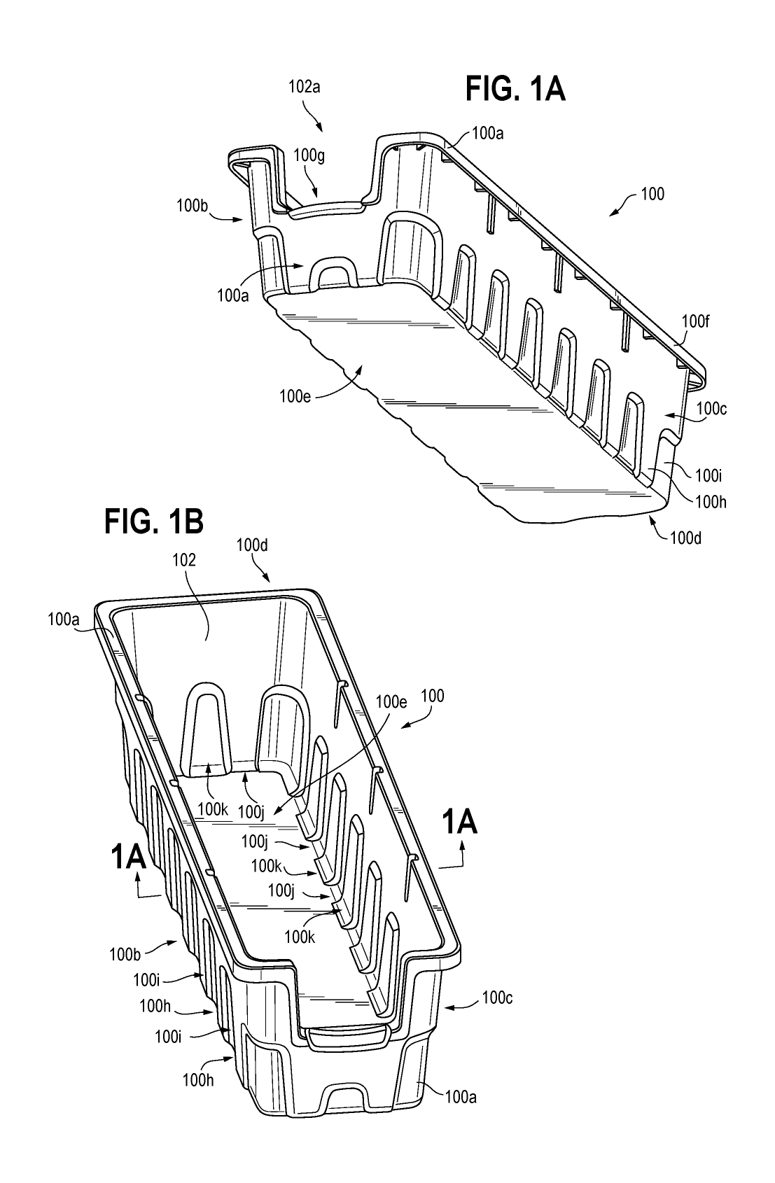

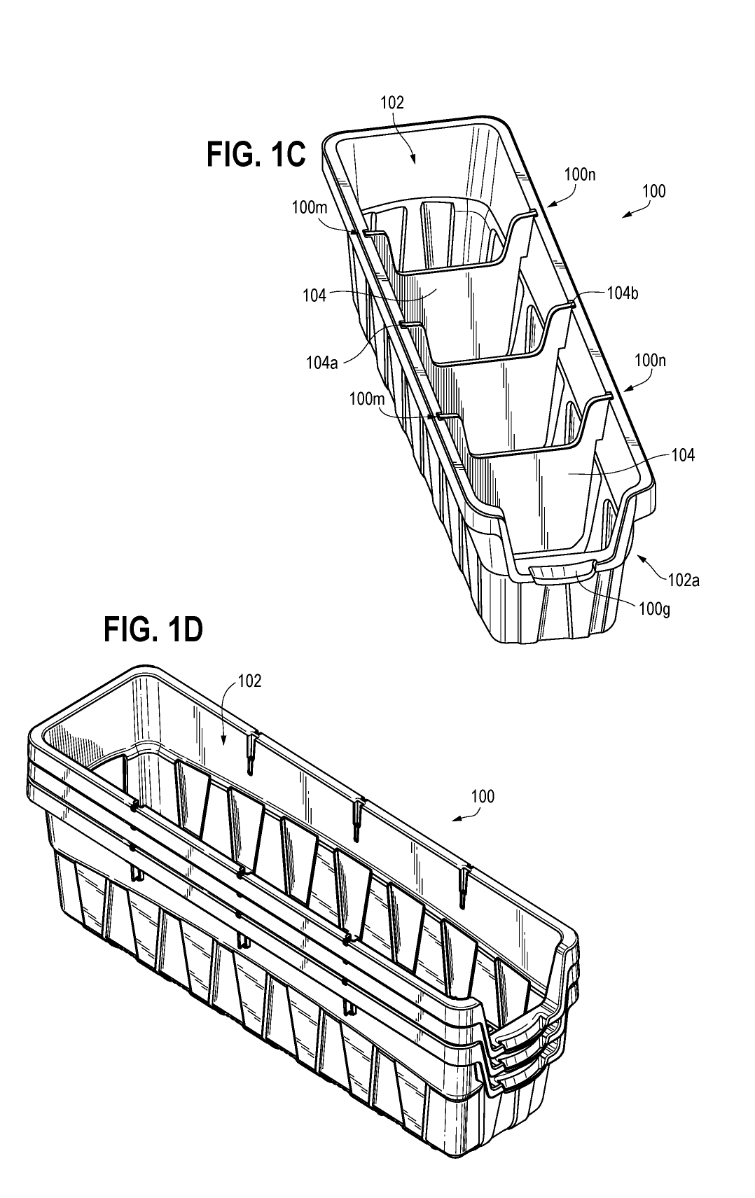

Turning now to the drawings and, in particular, FIGS. 1A-D, there is illustrated a receptacle, such as bin or tote 100, in accordance with some embodiments of the invention. In the form illustrated, tote 100 is preferably made via a plastic injection molded process and has a generally U-shaped cross-section when viewed along line A-A in FIG. 1B. This structure is formed from upstanding walls, such as first or front wall 100a, opposing side walls (or second and third walls) 100b and 100c, and fourth or rear wall 100d, which extend upward from generally planar bottom 100e. The upper lip or edge 100f of tote 100 that forms the receptacle opening 102 is preferably flanged and, even further, folded over upon itself with spaced ribs connecting same to form a stiff or rigid structure that helps stiffen the overall tote 100 and, in particular, the upper edge or lip 100f the tote will often be carried by.

The lip or edge 100f further defines a recess 102a in front wall 100a that serves as viewing window which a user may look or peer through to see the products contained in the receptacle or tote 100. In a preferred form, the recess 102a has a general U-shape and at the bottom of the U-shape of the recess, the upper edge or lip 100f of front wall 100a forms, or at least partially forms, handle 100g. As mentioned above, in a preferred form, the handle 100g is integrally formed with the remainder of the tote 100 so that the product can be removed from the mold a finished product or almost finished product. Even with recess 102a, front wall 100a provides for ample space for indicia such as labels, bin location tags, etc., as does rear wall 102d.

In addition to the above structure, the tote 100 may also have at least one upstanding wall defining a first male or female mating structure for aligning with a second female or male mating structure of a second plastic receptacle when nested with the second plastic receptacle. In the form illustrated, the side walls 100a-d include a plurality of male and female mating structures 100h and 100i, respectively, on the exterior of the unit, and mating female and male mating structures 100j and 100k, respectively, on the interior of the unit 100. These mating structures alternate with one another so as to form an alternating mating structure such as a repetitive tongue and groove type pattern and connection. Such an alternating mating arrangement helps align and guide the totes 100 when they are being stacked or nested with one another. In a preferred form and as shown, the male structures 100h taper from a wider portion above to a narrower portion below and the female structures 100i taper from a wider recess below to a narrower recess above (e.g., opposite the male structures 100h) in order to make it easier to initially stack or combine tote units 100 and then guide the totes into alignment as one is further inserted into the other (e.g., the narrowing of the recess and widening of the protrusion get closer together until they engage one another when the upper tote 100 is fully inserted into the lower tote 100. In some forms, the upper lips or flanges 100f of the totes abut one another when the upper tote is fully inserted in the lower tote.

As illustrated in FIGS. 1A-1D, the pattern of the mating structures 100h, 100i on the exterior and 100j, 100k on the interior continues even around the edges of the unit where one side wall transitions to another to further assist with the stacking and nesting of the units. In a preferred form, the exterior surface of the totes at the edge will define a recess 100i to mate with a corresponding male mating protrusion 100k to ensure the units are solidly stacked and nested together when the upper tote 100 is fully inserted in the lower tote 100, as is best illustrated in FIG. 1D.

In the form shown, the tote's U-shaped cross section is formed by the opposing side walls 100b, 100c and bottom wall 100e. In some forms, the front and rear walls 100a, 100d, respectively, may be spaced further apart from one another than the opposing side walls 100b, 100c are from one another in order to make a narrow and deep unit with a defined product channel that has a longitudinal axis extending from and through the front wall 100a and rear wall 100d. In other forms, however, the unit 100 may be square or may even be wider than it is deep. As mentioned above, the dimensions of unit 100 will preferably have a depth of four feet or less when used on a single conventional warehouse shelving unit, or eight feet or less when used on adjacent conventional warehouse shelving units. The width of each unit will also preferably be calculated to maximize horizontal packout on each shelf of the conventional warehouse shelving unit and appropriate to fit the width of the product to be stored in each bin or tote 100.

In some forms, the tote 100 may also include dividers 104 which can be inserted into the product channel of the tote 100 to divide the product channel into smaller compartments to hold smaller quantities of product or even individual products. In a preferred form, the interior surface of the opposing side walls 100b, 100c, will have divider mating structures for mating with the dividers 104. In the embodiment illustrated, the divider mating structures are recesses 100m and 100n located on the interior of left side wall 100b and right side wall 100c, respectively. When installed, dividers 104 have mating surfaces, such as outer edges that engage recesses 100m, 100n, respectively, to secure the divider 104 to the tote 100. In the form shown, the dividers 104 have tabs or flanges 104a, 104b extending from the left and right sides (or opposite sides) of the divider 104, which get aligned with and disposed in recesses 100m, 100n, respectively. It should be understood, however, that in other forms, the recesses 100m, 100n, could run from the upper lip 100f of the tote 100 down to the bottom or bottom floor 100e to receive the entire outer side edges of the divider 104 rather than having a tab or flange configuration.

In the form illustrated in FIGS. 1A-1D, the opposing side walls 100b, 100c extend up from bottom 100e at an obtuse angle so that the walls taper from a larger cross-section at the upper lip 100f or opening 102 of the receptacle down to a smaller cross-section at the bottom 100e. In view of this, dividers 104 similarly taper from a wider upper portion to a narrower lower portion to properly fit within tote 100. In some forms, front and rear wall 100a, 100d also taper or extend up at an obtuse angle from bottom 100e. However, in other forms, these walls may extend up from bottom 100e in a generally perpendicular or square manner. In such cases, the shape of the dividers 104 may be adjusted accordingly to accommodate or correspond to the shape of the product channel defined by the tote 100.

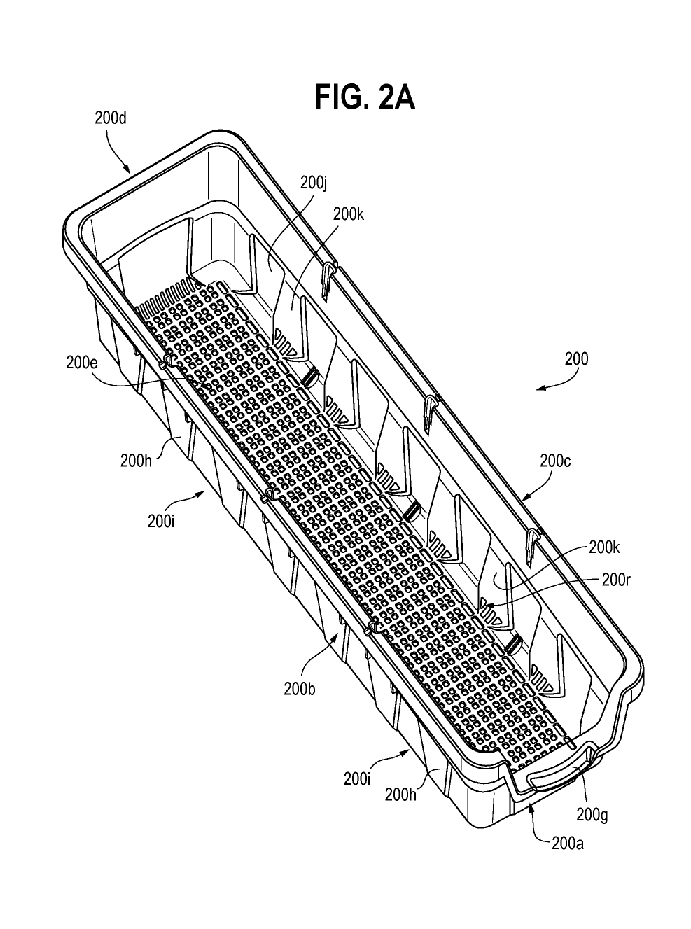

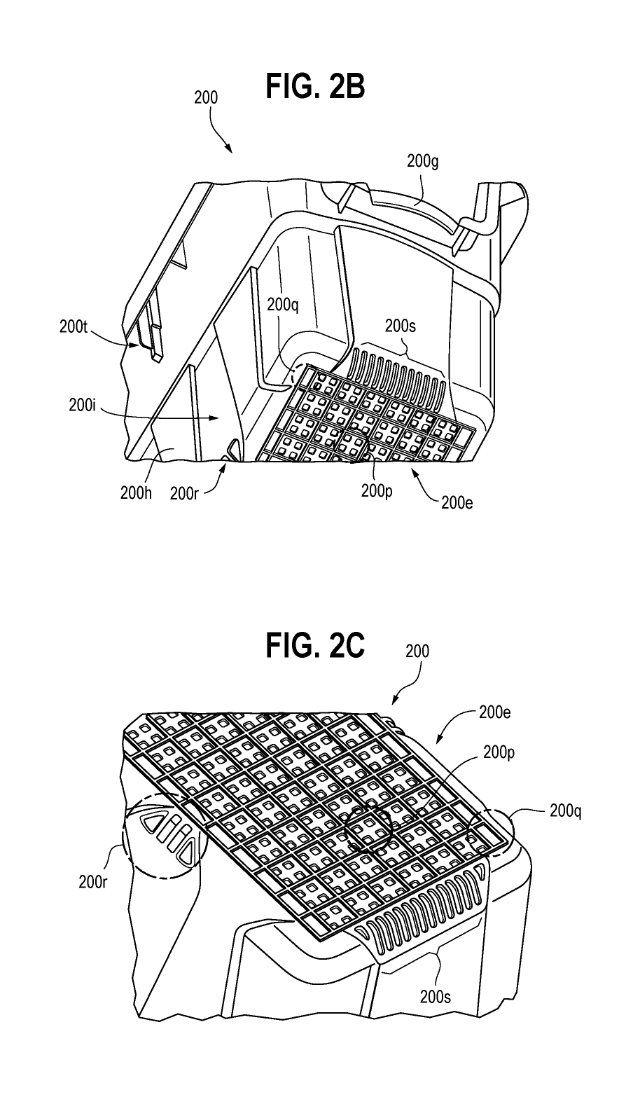

Other exemplary embodiments of totes in accordance with the invention are illustrated in FIGS. 2A-C herein and referred to generally by reference numeral 200. For purposes of brevity, items that are similar to those discussed above with respect to the embodiments of FIGS. 1A-D will use the same latter numeric and alpha identifier, however, these will be prefaced with the prefix 2 instead of 1 to distinguish one embodiment from the other. Thus, tote 200 includes front wall 200a, opposing side walls 200b and 200c, rear wall 200d and bottom 200e, just like tote 100 included similar walls 100a, 100b, 100c, 100d and bottom 100e. Front and rear walls 200a, 200d, respectively, provide for ample space for indicia such as labels, bin location tags, etc. Similarly, the tote includes upper lip or edge 200f which defines the receptacle opening 202 of tote 200, and front wall 200a includes a handle 200g (which again, in a preferred form, will be formed integral to the front wall 200a). The tote 200 may also include mating male and female structures 200h, 200i, respectively, on the exterior of tote 200 and corresponding mating female and male structures 200j, 200k, respectively, on the interior surface of tote 200. In some forms, tote 200 may also include divider mating structures, such as recesses 200m, 200n located on or in the interior surface of left and right walls 200b, 200c, respectively.

Unlike the prior embodiments of tote 100, however, tote 200 further includes openings to allow for ventilation or drainage of tote 200. In a preferred form, at least one of the bottom 200e and/or side walls 200a-200d define openings to allow for venting or drainage of the plastic receptacle 200. For example, in the form illustrated in FIGS. 2A-C, bottom 200e defines a first opening 200p. First opening 200p can take any different shape or size, however, in the embodiment illustrated it is in the form of a plurality of openings laid out in a pattern. Any pattern could be used (even random or prescribed/non-random), but in this embodiment the pattern is illustrated as a repetitive pattern of four openings set forth in a uniform square grid pattern. In alternate embodiments, the pattern does not have to be uniform or repetitive if desired.

Tote 200 further includes a second opening 200q. Like first opening 200p, second opening 200q is also located in the generally planar bottom 200e, however, second opening 200q is located at a perimeter of the bottom 200e. In a preferred form, the second opening 200q comprises a plurality of similarly shaped openings that are elongated and larger and different in shape than first openings 200p (which are round). Some benefits to having a larger or different shaped second opening 200q is that such openings can allow items to drain that might otherwise clog the first openings 200p. In the form illustrated, second openings 200q form outer gutters positioned on opposite sides of base 200e, between which the first openings 200p are located.

In still other forms, a third opening 200r is positioned on an outer, lower edge of tote 200. In the form illustrated, the third opening 200r comprises even larger openings that are different in shape or pattern than the first and second openings, 200p, 200q, respectively. The third openings 200r are positioned at regular intervals within tote 200. In the form illustrated, the third openings are positioned at the base of some of the internal male mating structures 200k and are capable of further draining objects that might otherwise clog first and second openings 200p, 200q, respectively.

In other embodiments, tote 200 further may include a fourth opening 200s which is located in another outer and lower edge and/or side of tote 200 and has a different shape or pattern than the first, second and third openings 200p, 200q and 200r. In the form illustrated, fourth openings 200s are positioned at opposite ends of tote 200 proximate front wall 200a and rear wall 200b. Fourth opening 200s has numerous individual openings within it and spans a width that is greater than twenty percent of the width of tote 200, but less than ninety percent of this width. In other forms, this range may be narrowed to forty to seventy-five percent of the width of the tote or simply rephrased as less than ninety percent of the width of the tote. These percentages may be raised or lowered as desired with the understanding that higher percentages attractively allow for more drainage and air circulation or venting, but weaken the strength of the structure (particularly when considering the desire to allow totes to be stacked one atop the other). Whereas lower percentages allow for a stronger tote structure, but limit the amount of draining and/or circulating the openings allow. It also should be understood that while specific opening shapes are illustrated, openings of different shape, size and number may be used to achieve the same results and, thus, the shapes and patterns selected are just one of many designs that could be adopted. The instant application is intended to cover a variations of shape, size and number of openings by covering the broad concept of same, not a specific design.

Tote 200 further includes stops or obstructions 200t which are used to prevent an upper tote from being inserted too far into a lower tote. In one form, the lower most surface of obstruction 200t abuts a structure on a lower tote that the tote 200 is being stacked or nested on. Such structures are also present on tote 100, but are harder to see in those drawings. These stops or obstructions 200t also reinforce and strengthen the side walls of the tote 200.

Thus, it should be understood that the embodiments disclosed herein solve one or more of the above mentioned problems associated with conventional cardboard totes. For example, the plastic material of totes 100 and 200 does not breakdown easily and can withstand much more wear and tear than its cardboard counterpart. The material and structure of totes 100 and 200 further allow them to be stackable and nested with one another (making for more efficient use of space on the warehouse shelves and within the warehouse in general). Totes 100 and 200 are further easy to sub-divide with dividers so that individual products can be separated from one another which can protect the stored product and/or make it easier for associates to perform their required pick activity. The material and structural strength of totes 100 and 200 further make them less susceptible to breakage and/or infestations, and reduce the risk of tears in sidewalls or sidewall collapses, that can result in comingling of stored product and/or presence of the incorrect product in a tote (which can ultimately lead to inventory and order errors). The material and structural strength and layout of totes 100 and 200 further provide ample space for indicia such as labels, bin location tags, etc. and protects same from the same wear and tear associated with conventional cardboard totes. Further, totes 100 and 200 can be easily washed or cleaned and used with food or product that has condensation buildup or in environments with high humidity due to how well the material holds up against such elements or environments. Totes 100 and 200 allow the entire bay to be utilized in conventional warehouse shelving units and allows product to be cleanly and clearly separated into bins for easy pick and pack processing. Lastly, tote 200 further allows for venting and drainage and, thus, can be without concern over leakages occurring or concern over liquids being introduced into the environment such as leaking products, leaking roofs, sprinkler systems or other fire abatement activity, etc. In fact, tote 200 satisfies the requirements of many fire codes and complies with the National Fire Prevention Agency regulations guiding in-rack storage and has been certified for same. The plurality of holes defined by tote 200 further reduce the weight of same and, thus, make it an all-around attractive solution for most retailer and warehouse/logistic needs.

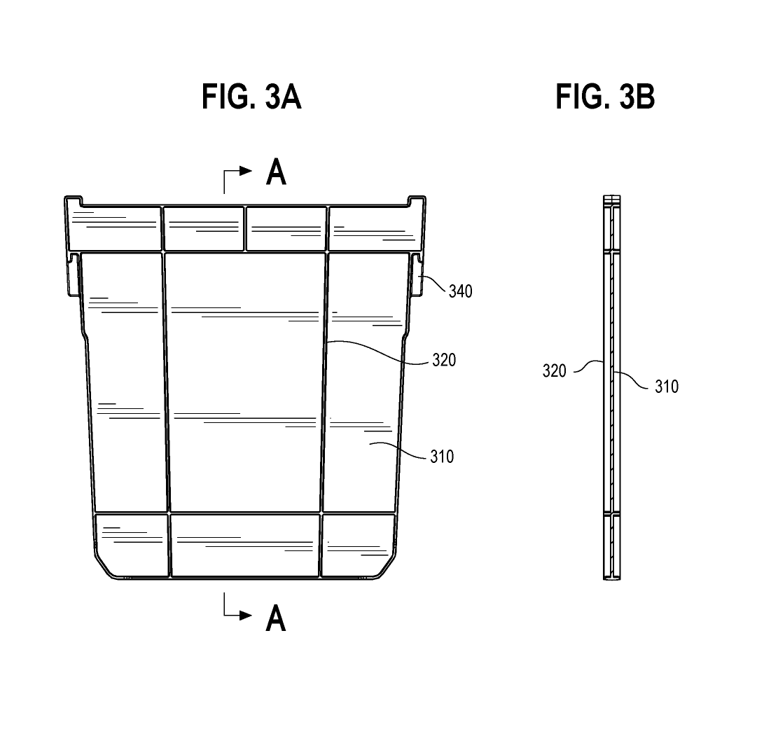

Next referring to FIGS. 3A and 3B, a divider is shown. FIG. 3A comprises a front view of the divider 300 and FIG. 3B comprises a cross-sectional view of the divider 300 through line A-A. In some embodiments, the divider 300 shown in FIGS. 3A and 3B may comprise the dividers 104 described with reference to FIG. 1C or similar structures. The divider 300 is configured to be inserted into divider mating structures of a tote or bin described herein to divide the product channel into smaller compartments to hold smaller quantities of product and/or individual products.

The divider 300 comprises a divider wall 310, a rib portion 320, bin mating tags or flanges 330, and a top portion 340. The divider wall 310 comprises a rigid or semi-rigid material that is sized to fit into the height and width of a product channel of a bin or a tote. The rib portion 320 comprises thickened portions of the divider wall 310 configured to increase the rigidtness of the divider wall 310. In FIG. 3, the rib portions 320 includes a thickened rim of the divider wall 310, two horizontal ribs extending the width of the divider wall 310, two vertical ribs extending the height of the divider wall 310, and a partial rib between the two vertical ribs extending from the top of the divider wall to the first horizontal rib. In some embodiments, the lower corners of the divider 330 may comprise openings in rib portion 320 configured to slide into and mate with recesses in the bottom corners of the product channel of a tote or bin. In some embodiments, the lower corners of the divider 330 may comprise thickened portions configured to slide into and mate with recesses in the bottom corners of the product channel of a tote or bin. In some embodiments, the rib portion 320 may comprise other shapes, thickness, and configuration without departing from the spirit of the present disclosure.

The bin mating tags or flanges 330 extend beyond the lower portion of the divider wall 310, and are configured to be inserted into recesses of a bin or a tote. In some embodiments, the bin mating tags or flanges 330 of the divider 300 may be configured to be inserted into recesses 100m, 110n, 200m, and/or 200n or similar recesses. The top portion 340 of the divider 300 comprises a widened portion of the divider wall 310 that is configured to remain above the recesses of the bin or the tote when the mating tags or flanges 330 are inserted into the recesses.

The illustrations of the divider 300 in FIGS. 3A and 3B are provided as examples only. Dividers configured for use with bins or totes described herein may be variously configured.

While the above-mentioned embodiments have referenced some exemplary items or features, it should be understood that those are merely exemplary items or features and that alternate embodiments may use other items or features of this type. For example, other bin or tote structures utilizing the concepts discussed herein are further contemplated and intended to be covered by this disclosure. Similarly other systems and methods for handling product are also contemplated and intended to be covered.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A tote for the storage of product comprising:
a plastic receptacle having a generally planar bottom with upstanding walls extending from the bottom and defining a receptacle opening on a side opposite the bottom,
the upstanding walls forming a front wall, opposing side walls and a rear wall, with the walls extending from the bottom so that the receptacle tapers from a larger cross-section at the receptacle opening to a smaller cross-section at the bottom,
with at least one upstanding wall defining a first male or female mating structure for aligning with a second female or male mating structure of a second plastic receptacle when nested with the second plastic receptacle.

2. The tote of claim 1 wherein the front wall integrally forms a handle for grasping the tote to move same and a recess defining a viewing window to see products stored in the plastic receptacle.

3. The tote of claim 2 wherein the recess comprises a generally U-shaped opening in an upper portion of the front wall, with a protruding lip extending from a lower portion of the U-shaped opening defining at least a portion of the handle.

4. The tote of claim 1 further comprising one or more dividers, wherein the opposing side walls define divider mating structures for engaging corresponding mating structures on the one or more dividers.

5. The tote of claim 4 wherein the divider mating structures are recesses formed in an inner surface of each of the opposing side walls, with recesses located opposite one another for receiving exterior surfaces of a single divider.

6. The tote of claim 5 wherein the opposing side walls are positioned closer to one another than the front and rear wall are to one another so that the plastic tote defines a product channel having a longitudinal axis running between the front and rear walls and the one or more dividers are connected to the plastic tote in a manner that is transverse to the longitudinal axis of the product channel defined by the plastic tote.

7. The tote of claim 1 wherein the at least one upstanding wall defining the first male or female mating structure comprises a plurality of male protrusions extending from interior surfaces of the opposing side walls and having corresponding female recesses on exterior surfaces of the side walls opposite the male protrusions so that the male protrusions of the first plastic receptacle are slidable within the exterior female recesses of the second plastic receptacle in order to stack and nest the receptacles to one another.

8. The tote of claim 1 wherein the at least one upstanding wall defining the first male or female mating structure comprises a plurality of female recesses within interior surfaces of the opposing side walls and having corresponding male protrusions on exterior surfaces of the side walls opposite the female recesses so that the male protrusions of the second plastic receptacle are slidable within the female recesses of the first plastic receptacle in order to stack and nest the receptacles to one another.

9. The tote of claim 1 wherein the at least one upstanding wall defining the first male or female mating structure comprises a plurality of male protrusions and female recesses on interior surfaces of the opposing side walls and having corresponding female recesses and male protrusions on exterior surfaces of the side walls opposite the male protrusions and female recesses of the interior surface, respectively, so that the female recesses and male protrusions on an exterior surface of the second plastic receptacle are slidable within the male protrusions and female recesses, respectively, on the interior surface of the first plastic receptacle in order to matingly stack and nest the receptacles to one another.

10. The tote of claim 1 wherein at least one of the bottom and/or opposing side walls define openings to allow for venting or drainage of the plastic receptacle.

11. The tote of claim 10 wherein the bottom defines a plurality of openings laid out in a pattern.

12. The tote of claim 11 where the pattern is a uniform grid pattern of openings.

13. The tote of claim 10 wherein the opposing side walls define at least a portion of the openings for venting or drainage of the plastic receptacle.

14. The tote of claim 13 wherein a portion of the opposing side walls and bottom define the openings for venting or drainage of the plastic receptacle.

15. The tote of claim 14 wherein the bottom defines rounded openings having a vertical axis passing through the rounded openings and the opposing side walls and/or bottom define elongated slots.

16. The tote of claim 15 wherein at least one of the elongated slots extends from one of the opposing side walls to the bottom thereby wrapping around a bottom edge of the plastic receptacle.

17. The tote of claim 10 wherein a plurality of different openings are defined by the plastic receptacle, with at least a first opening having a different shape and location as a second opening.

18. The tote of claim 17 wherein the first opening comprises a plurality of openings located on the generally planar bottom of the plastic receptacle and the second opening comprises a plurality of openings located on an outer edge or side of the plastic receptacle.

19. The tote of claim 1 further comprising a plurality of plastic totes stackable and/or nestable within one another to maximize packout within a warehouse shelving unit and for transportation.

20. The tote of claim 1 wherein the opposing side walls of the plastic receptacle are spaced closer to one another than the opposing front and rear walls are to one another and the opposing front and rear walls have a length extending between them that is greater than four feet and less than or equal to eight feet to allow the plastic receptacle to extend over two conventional warehouse shelving units positioned adjacent one another.

21. The tote of claim 20 wherein the front wall defines a first handle and the rear wall defines a second handle so that a user can grasp the plastic receptacle from either end or either side of the two conventional warehouse shelving units positioned adjacent one another to access product contained in the plastic receptacle.

22. A pick and pack method for warehouse management comprising:
providing a plastic receptacle according to claim 1 wherein the front wall defines a first handle and the rear wall defines a second handle; and
positioning the plastic receptacle on first and second conventional warehouse shelving units positioned adjacent one another so that the user can grasp the plastic receptacle from either the first handle proximate the first conventional warehouse shelving unit or the second handle proximate the second conventional warehouse shelving unit; and
moving the plastic receptacle between a first position wherein the plastic receptacle is intermediately positioned or centered between the first and second conventional warehouse shelving units so that neither the front end nor the rear end extends beyond an outer edge of the first and second conventional warehouse shelving units, respectively.

23. The pick and pack method of claim 22 wherein moving the plastic receptacle comprises moving the plastic receptacle between a first extended position wherein the front wall of the plastic receptacle protrudes from the first conventional warehouse shelving unit and a second extended position wherein the rear wall of the plastic receptacle protrudes from the second conventional warehouse shelving unit.

24. A pick and pack system comprising:
a plurality of plastic receptacles according to the plastic receptacle of claim 1 positioned adjacent one another in a row on shelving surfaces comprised of a first and second conventional warehouse shelving units which are also positioned adjacent one another.

25. The pick and pack system of claim 24 wherein the plurality of plastic receptacles are positioned proximate one another in multiple rows on multiple shelving surfaces defined by the first and second conventional warehouse shelving units which are also positioned adjacent one another.

26. The pick and pack system of claim 24 wherein the plurality of plastic receptacles are arranged in a plurality of rows of plastic receptacles with an upper row of the plurality of plastic receptacles being formed by stacking or nesting the upper row of the plurality of plastic receptacles on top of a lower row of the plurality of plastic receptacles to make more efficient use of the shelving surfaces comprised of the first and second conventional warehouse shelving units.
